(19) United States
(12) Patent Application Publication
(10) Pub. No.: US 2002/0172930 A1
(43) Pub. Date: Nov. 21, 2002

(54) Fill-in-the-blank applet

(75) Inventor: Thomas M. Sirhall, Littleton, CO (US)

Correspondence Address: LAHIVE & COCKFIELD, 28 STATE STREET, BOSTON, MA, 02109, US

(73) Assignee: Sun Microsystems, Inc.

(21) Appl. No.: 09/820,123

(22) Filed: Mar. 28, 2001

(51) Int. Cl. G09B 7/00

(52) U.S. Cl. 434/322

(57) ABSTRACT

An interactive applet for testing a user in a web-based learning environment. The interactive applet is embedded in a course page of a web-based curriculum. The applet provides question to a user regarding the information presented in the course, followed by a text field. The applet instructs the user to enter an answer to the question in the text field. The applet provides feedback to the user, and allows the user to revise an incorrect answer.

### FIELD OF THE INVENTION

The present invention relates to a web-based learning environment. More particularly, the present invention relates to an interactive software tool for testing a user from a remote location.

### BACKGROUND OF THE INVENTION

The Internet has revolutionized educational opportunities by accommodating on-line educational courses. On-line educational courses can provide a diverse educational curriculum without imposing long-distance travel on students. Furthermore, on-line educational courses accommodate students with a wide variety of lifestyles, provide learning at an appropriate pace for a student and can accommodate a student's time constraints. A student may enroll in a periodic on-line educational course to learn about a new technology or other subject of interest without disrupting participation by the student in other activities, such as a full-time job or activities with their family.

However, a drawback of current learning opportunities over the Internet is the difficulty in testing a student. In the traditional classroom setting, testing has proven to be extremely beneficial to the learning process of a student. Testing helps assess a student's retention and absorption of presented information and allows an instructor to chart a student's progress through the learning process. Testing also serves to reinforce and emphasize the presented information in the mind of the student. Testing further provides feedback to an instructor or course creator regarding the clarity and comprehensiveness of the material presented. Without an effective testing process, a distance-learning student may be merely a passive viewer of information, rather than an active participant in the educational process.

### SUMMARY OF THE INVENTION

The present invention provides an interactive software application for testing a user's knowledge in a web-based learning environment. According to an illustrative embodiment, the present invention provides an interactive applet embedded in a course page of a web-based curriculum. The applet provides a question to a user regarding the information presented in the course and instructs the user to provide an answer to the question. The applet provides feedback to the user, and allows the user to revise an incorrect answer.

According to an illustrative embodiment, the present invention provides a method comprising providing an interactive fill-in-the-blank applet, wherein the applet generates a Web page displaying a text box, a question and instructions to a user to enter an answer to the question in the text box.

According to an alternate embodiment, the present invention provides a method comprising receiving a request for a Web page and in response to said receiving step, sending a Web page. The Web page contains a question and a fill-in-the-blank applet embedded therein. The fill-in-the-blank applet displays instructions to a user to enter an answer to the question provided by the Web page.

According to another embodiment, the present invention provides a computer-readable medium for use in an electronic device. The computer-readable medium comprises instructions for running a fill-in-the-blank applet for displaying a question and a text box to a user, wherein the user can enter an answer to the question in the text box.

According to yet another embodiment, the present invention provides an electronic device comprising a processor, a display screen and memory. The memory of the electronic device includes a Web page having an interactive fill-in-the-blank applet embedded therein. The processor of the electronic device executes the fill-in-the-blank applet to generate a graphical user interface on the display screen. The graphical user interface displays a question, a text box and instructions to a user to enter an answer to the question in the text box.

### BRIEF DESCRIPTION OF THE DRAWINGS

FIG. 1 is a block diagram of a distributed environment suitable for implementing an on-line educational course and running the fill-in-the-blank applet of an illustrative embodiment of the present invention.

FIG. 2 is a block diagram of a client machine suitable for use in the illustrative embodiment.

FIG. 3 illustrates a web page including the fill-in-the-blank applet of the illustrative embodiment.

FIG. 4 illustrates the fill-in-the-blank applet when a user enters a correct answer to the question asked by the applet.

FIG. 5 illustrates the fill-in-the-blank applet after the user has incorrectly answered the question.

FIG. 6 illustrates the fill-in-the-blank applet after the user has made the maximum attempts allowed to enter a correct answer.

FIG. 7 illustrates the fill-in-the-blank applet after the user has entered an incomplete answer.

FIG. 8 is a flow chart illustrating the steps involved in creating a fill-in-the-blank applet according to an illustrative embodiment of the present invention.

### DETAILED DESCRIPTION OF A PREFERRED EMBODIMENT

FIGS. 1 through 8, wherein like parts are designated by like reference numerals throughout, illustrate an example embodiment of a software application suitable for interacting with a user to test the user on information presented in an on-line educational course. Although the present invention will be described with reference to an illustrative embodiment shown in the figures, those skilled in the art will appreciate that the present invention may be implemented in a number of different applications and embodiments and is not specifically limited in its application to the particular embodiment depicted herein.

The software application of the illustrative embodiment provides a mechanism by which a provider of an on-line network learning center can test a student on information presented in an on-line education course setting of an on-line network learning center environment. An “on-line network learning center” is an organization that provides instruction over a computer network such as a Local Area Network (LAN) or the Internet. An on-line network learning center maintains a server having a domain name associated with the learning center. Administrators of the learning center develop, create, edit and/or administer an on-line educational course. An “on-line educational course” is curriculum, such as a training course for a new technology, that is delivered to a student over a computer network. Course material in the on-line educational course may consist of many units or chapters and may include text, graphics, sound, movies and exercises to be performed by the student. Through the use of the software application, a fill-in-the-blank applet, the student is presented with a question related to the information presented in an on-line course, followed by a text box for entering an answer. The applet provides feedback to the student informing the student if he has correctly answered the question. If the student is incorrect, the applet invites the student to try again. After a predetermined number of attempts, the applet automatically provides a correct answer to the student.

The present invention can be implemented in an on-line educational learning center. The learning center may provide on-line opportunities for students to enroll in educational courses pertaining to any number of different subject areas and to be tested on the information presented in the course. The exam questions that exist within the on-line learning center can be provided by the creator and host of the learning center, or can be provided by third parties (e.g. universities or vendors). A third party wishing to submit and create exam questions utilizing the interactive applet of the present invention can access a learning center Web site, using a browser such as the HotJava browser from Sun Microsystems, Inc. of Palo Alto, Calif. or Netscape Navigator from Netscape Communications. The browser utilized, for the purposes of the embodiments illustrated herein, supports the JAVA language, so that the third party can provide exam questions to the on-line learning center. A JAVA applet may guide the third party through the process of creating exam questions for an on-line course within the on-line learning center structure.

JAVA is an object-oriented, platform-independent computer programming language and environment suitable for writing programs that run over the Internet. JAVA is a trademark and registered trademark of Sun Microsystems, Inc. in the United States and other countries. As used herein, the term “applet” refers to a program designed to be executed from within another application. An applet is typically a small, specialized application written in the JAVA programming language that can be included in an HTML or XML page, much in the same way an image is included and can be executed in a Web browser. Applets allow developers to add “interactive” content to Web documents (such as animation, page adornments, games, etc). Applets can be downloaded from a Web server and executed within a JAVA-compatible browser (e.g. HotJava) by copying code from the Web server to a client. JAVA source code files (i.e. files with a .java extension) are compiled by a JAVA compiler to produce instructions in bytecode (i.e. files with a .class extension), which can then be executed by a JAVA virtual machine (VM). JAVA VM's are available for different platforms and thus, help to provide “platform independence” for JAVA programs.

To run a JAVA applet from a Web site, the site developer inserts applet tags (i.e. <applet>) into an HTML document, an XML document or the code of some type of page description language, which instruct the browser to download the appropriate classes from the Web server and then interpret the classes. “Classes” define JAVA program building blocks, called objects, as well as the behavior and attributes of the objects. Specifically, the tag identifies the JAVA classes needed for running the applet and may also set parameter values for the applet.

The illustrative embodiment of the present invention is described relative to an applet in the JAVA programming language. However, the present invention is not limited to the specific embodiment. It should be noted that other languages can have different forms of a program that perform the same function, and the present invention can be used in a programming environment other than JAVA. Furthermore, the present invention is not specifically limited to a JAVA applet executed from a Web browser, and may be implemented as various types of code modules in accordance with the teachings of the present invention.

FIG. 1 illustrates a block diagram of a distributed environment 100 suitable for implementing an on-line educational course and running the fill-in-the-blank applet of the illustrative embodiment of the present invention. The distributed environment 100 includes a Web server 101 and a plurality of client machines 102 connected to the Web server 101 and running a JAVA-enabled Web browser 103. The Web server 101 and the client machines 102 are connected to a network 100 via communications links 104. The Web server 101 includes a database 105, servlets 106 and Web pages 107 generated by the servlets 104. The Web browsers 103 on the client machines 102 locate and display Web pages. A Web browser further includes an HTML interpreter.

FIG. 2 is a more detailed block diagram of an exemplary client machine 102. The client machine includes a central processing unit 109, a keyboard 110 enabling a user to enter data into the client machine, a video display screen 111 and a mouse 112 or other pointing device for controlling the movement of a cursor or pointer on the display screen 111. The client machine further comprises a network interface 113 for connecting the client machine to the Internet, a modem 114 for formatting data to be transmitted over telephone lines, coaxial cables or other suitable transmission lines, a decoder 115 for translates encoded data to its original format and client memory 116. The memory 116 contains Web pages 107 including embedded applets 117 or other software applications, a JAVA-enabled Web browser 103, and a JAVA class library 118 containing the JAVA classes needed to run the applets or other software applications. The client machine can be a PC, workstation, Internet appliance, cell phone, intelligent pager or other suitable device for running an on-line educational course.

To run the interactive fill-in-the-blank applet of the illustrative embodiment of the present invention, the Web server 101 sends an HTML document with an embedded fill-in-the-blank applet to a client machine 102 of the network 100. The HTML interpreter 108 then interprets the HTML document. The Java VM in the Web browser executes the fill-in-the-blank applet and displays a Web page on the video display screen 111 of the client machine 102. The GUI, which will be described in detail with reference to FIGS. 3 through 7, displays a question to a user and includes a box where the user can input an answer to the question.

FIG. 3 illustrates a Web page 10 generated by executing a fill-in-the-blank applet according to an illustrative embodiment of the present invention. The illustrated fill-in-the-blank applet tests a user regarding information presented in an on-line JAVA tutorial. In FIG. 3, the interactive fill-in-the-blank applet is executed within the environment of a Netscape Navigator browser 11. The Web page 10 of the illustrative fill-in-the-blank applet displays question box 12 including a question related to information taught in an on-line course and instructions to the user. The Web page further includes a text box 13. The user is required to type an answer to the question in the text box. A label 15 directs the user to the text box 13. The Web page includes function buttons 19, 21 to facilitate interaction with the user. When a user clicks on a function button using a mouse or other pointing device, the applet responds according to particular instructions stored in an applet file.

In the Web page illustrated in FIG. 3, an HTML document provides a static background for the applet, including the instructions and/or question to the user. For example, the HTML document includes a logo 14 and the question box 12 including the question to the user.

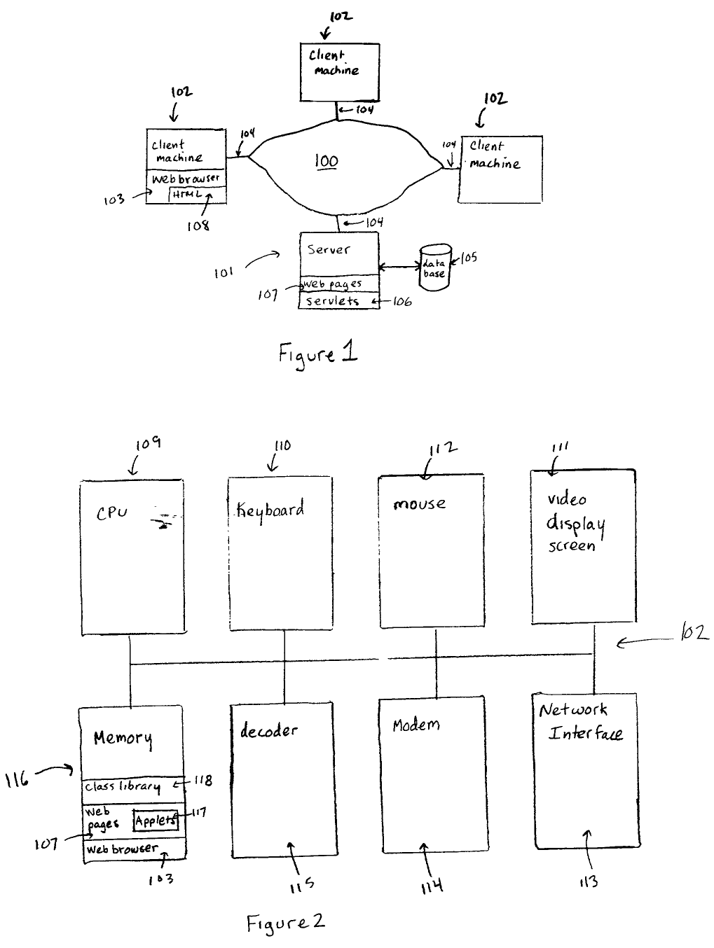

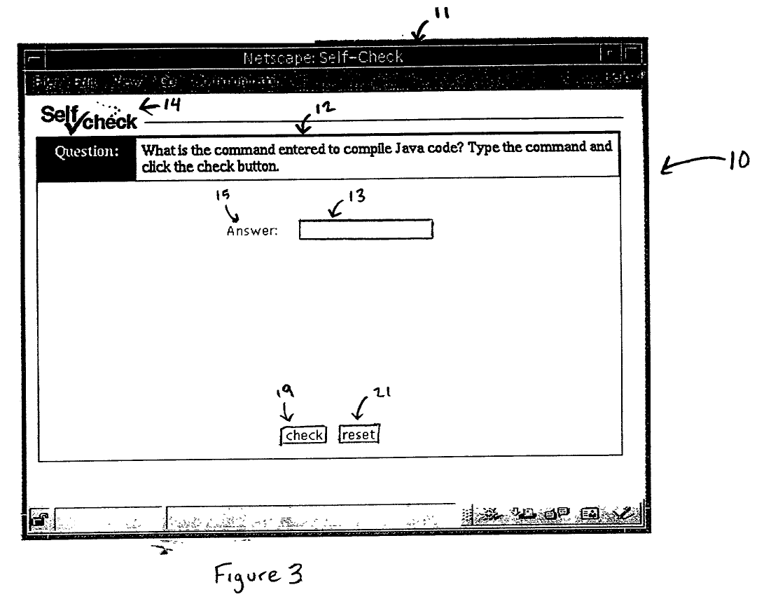

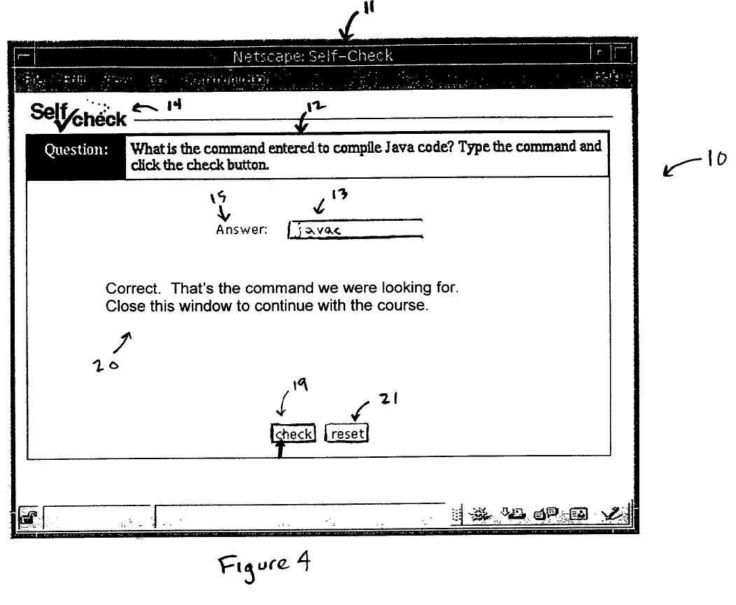

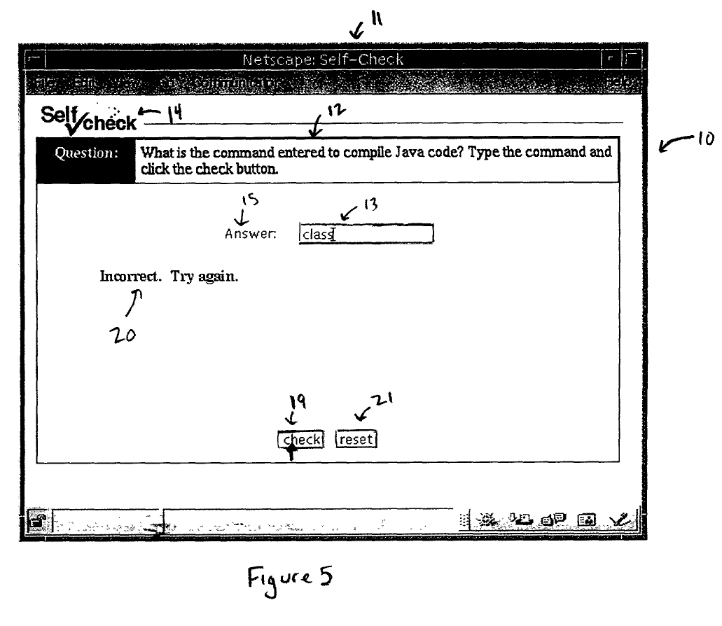

In FIG. 4, the user completes typing in an answer and presses the “check” button 19 to assess his selections. If the user has entered a correct answer, the applet provides positive feedback in feedback site 20 to the user. According to the illustrative embodiment, the positive feedback in response to a correct match reads “Correct. That's the command we were looking for. Close this window to continue with the course.” According to the illustrative embodiment, the applet is contained in a “pop-up” web page that is accessed at a particular point in the on-line course, such as after the user finishes a lesson, or another applet. After the user completes the activity, the applet directs the user back to the on-line course.

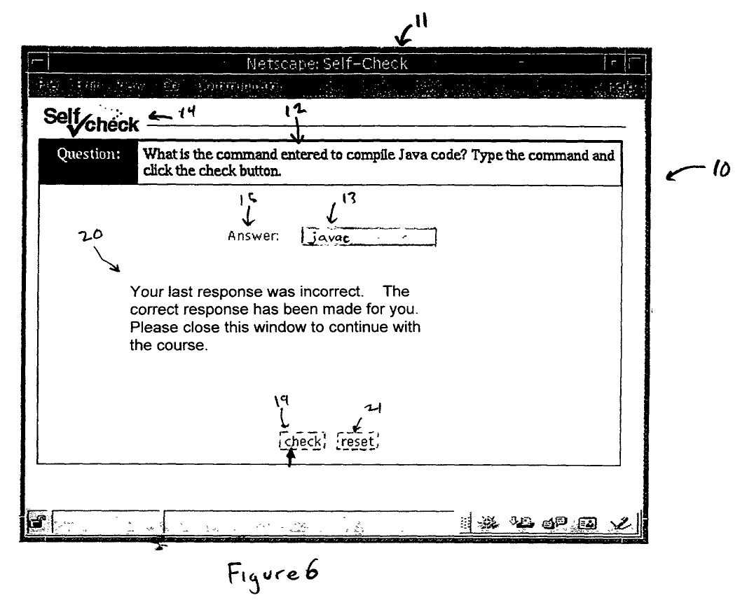

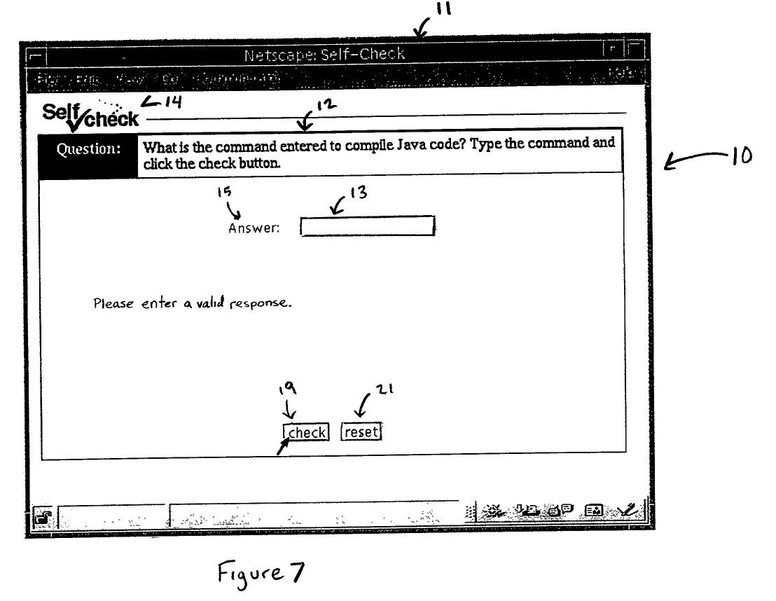

However, if the user enters an incorrect answer, the applet provides a negative feedback in the feedback site 20 and prompts the user to try again, as illustrated in FIG. 5. In the illustrative embodiment the negative feedback is “Incorrect. Try again.” The fill-in-the-blank applet includes a “reset” button 21 to allow the user to clear his entry. After a predetermined number of failed attempts, the applet automatically provides the correct answer to the user, as illustrated in FIG. 6. According to the illustrative embodiment the correct answer to the question “What is the command entered to compile JAVA code” is “javac”. According to the illustrative embodiment, after three attempts, the applet notifies the user “Your last response was incorrect. The correct response has been made for you. Please close this window to continue with the course.” The applet also disables the function buttons 19, 21 to prevent the user from subsequent action. According to the illustrative embodiment, there may be more than one correct answer for a particular question. For example, the terms “java” “*Java” are also correct answers to the question recited in the question box 12.

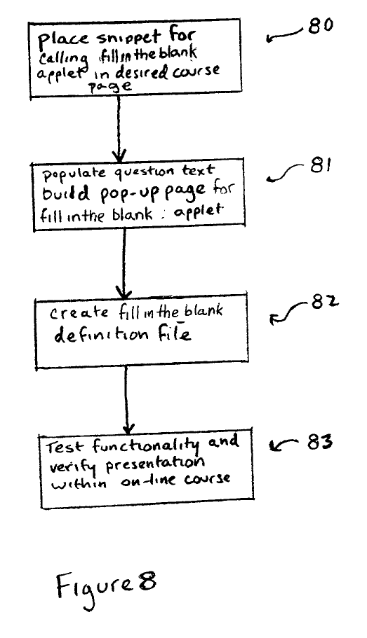

According to one embodiment, shown in FIG. 7, the applet further provides feedback to the user regarding an incomplete answer. If the user fails to enter a word and then presses the “check” button 19, the applet responds “Please enter a valid response” or other similar command in the feedback site 20.

According to the illustrative embodiment of the present invention, the fill-in-the-blank applet is embedded in a page within an on-line course that is sent to a client machine of the user from a server for the on-line network learning center. The page is an HTML, XML, or other page description language document including a link to the applet. An HTML file is a hypertext markup language file conventionally used in creating documents on the World Wide Web or Internet. HTML defines the layout and structure of the file, using various tags and attributes. As discussed, the HTML file used in conjunction with the fill-in-the-blank applet of the present invention can include exam questions and reference the JAVA fill-in-the-blank applet that presents a question to the student, and then checks the answers.

An example of an HTML fragment suitable for implementation in the illustrative case includes the following code:

<html>
<body bgcolor=“#ffffff” topmargin=“0” leftmargin=“0” marginwidth=“0”
marginheight=“0”>
<table align=“center” cellspacing=“5” cellpadding=“0” border=“0”>
<tr>

<td>

<table cellspacing=“0” cellpadding=“0” border=“0”>
<tr>

<td><img src=“../../../self-check-title.gif” align=“left”></td>

</tr>
</table>
<div align=“center”>
<table width=“98%” border=“0” cellspacing=“0” cellpadding=“1”
bgcolor=“#000000”>
<tr>

<td>

<table border=“0”cellspacing=“0” cellpadding=“1”

width=“100%”>

<tr>

<td height=“22”>

<table width=“100%” border=“0” cellspacing=“0”

cellpadding=“5” bgcolor=“#FFFFFF”>

<tr>

<td width=“17%” valign=“top” bgcolor=“#000000”

align=“center”><b><font color=“#FFFFCC”>Question:</font></b></td>

<td width=“83%” bgcolor=“#e4e4e4”>What is the

command entered to compile Java code? Type the command and click the
check button. </td>

</tr>

</table>

</td>

</tr>
<tr bgcolor=“#FFFFFF”>

<td height=“22”>

<table width=“100%” border=“0” cellspacing=“0”

cellpadding=“5”>

<tr><td>&nbsp;</td></tr>

<tr>

<td>

<div align=“center”>

This code defines the attributes of the HTML document wherein the fill-in-the-blank applet is embedded. Tag <td width=“83%” bgcolor=“#e4e4e4”> of the code precedes the question and instructions to the user displayed in question box 12 in FIG. 3. The HTML code can be run with the help of a browser such as HotJava or Netscape Navigator. The questions can be viewed by any user running the HTML code using a browser by looking at the source code. Generally, a user can easily view the source code for a Web page by positioning a mouse pointer on the web page and clicking on the right button of the mouse. According to the present invention, the answers to the question are included in a separate file and are not generally available to the user.

The HTML code further includes an applet tag. The applet tag instructs the browser to load an applet having the attributes defined by the tag. The browser calls a fill-in-the-blank applet of an illustrative embodiment of the present invention with the following applet tag HTML code:

<applet codebase=“<prop servletname>content:/java/”

archive=“SESTBTInteractivity.jar” code=“FillintheBlank” width=“500”

height=“450”><param name=“file” value=“fillintheblank.def”><param

name=“TBTServletBase” value=“<prop servletname>”><param

name=“TBTDocumentBase” value=“<subst contentPageDocBase>”></applet>

The browser loads the applet class files for the fill-in-the-blank applet into a JAVA interpreter and calls a definition file defined by the applet tag and corresponding to the fill-in-the-blank applet. The tag tells the applet viewer or browser to load the applet whose compiled code is in the file “FillintheBlank” and sets the initial size of the applet to 500 pixels in length and 450 pixels in height. The “codebase” parameter specifies the base URL of the applet (the directory that contains the applet's code). The “archive” parameter of the tag describes one or more archives containing classes and other resources for the fill-in-the-blank applet. The jar files referenced in the archive are compressed versions of JAVA files, suitable for transporting over a network, such as the Internet. The “param name” parameters specify an applet-specific attribute. The first param name invokes a definition file for the fill-in-the-blank applet. The second param name parameter, TBTServletBase, specifies the server for the applet and the parameter TBTDocumentBase specifies the directory containing the SESTBTInteractivity.jar file.

The JAVA definition file written for the fill-in-the-blank applet of the present invention includes the answers and other parameters of the applet, which are hidden from the user. The applet tag directs the browser to the definition file “fillintheblank.def” stored on the server. The definition file defines the appearance of the applet and includes a number of attribute tags. For example, a definition file for the fill-in-the-blank applet of the illustrative embodiment the present invention may include the following code, which is illustrative of one embodiment of the invention and is not to be construed in a limiting sense:

@bgcolor

white

@rows

1

@columns

15

@scrollbars

none

@setlabel

Answer:

@correct

@exactmatch

javac

@correct

@exactmatch

Java

@correct

*Java

@correctfeedback

Correct. That's the command we were looking for. Close this window to continue with the course.

@incorrectfeedback

Incorrect. Try again.

The definition file tags define particular parameters of the applet. In the example set forth above, “bgcolor” defines the color to be displayed as a background. As defined by the illustrative definition file of the fill-in-the-blank applet, the background color is set to white. The tag “rows” defines the number of rows for the text field and the tag “columns” defines the number of columns in the text field. In the illustrative example, the fill-in-the-blank applet includes one row and fifteen columns for the text field. The tag “scrollbars” defines the number of scrollbars visible in the fill-in-the-blank applet. According to the illustrative embodiment, no scrollbars are visible. The tag “setlabel” defines the text before the text field. In the illustrative example, the label is “Answer:”. The tag “correct” defines the text to be associated with a correct response. According to the illustrative embodiment, an “exactmatch” tag follows two of the “correct” tags. The “exactmatch” tag requires that the response entered by the user exactly match the text in the “correct” tag in matters of case sensitivity. According to the illustrative embodiment, the fill-in-the-blank applet requires that the user either enter “javac” or “Java” with the precise case sensitivity, or “*Java”, without having to exactly matching the text. The tag “correctfeedback” defines the feedback to be given to the user when the user enters a correct answer. Finally, the tag “incorrectfeedback” defines the feedback to be given to the user when the user enters an incorrect answer.

The definition file may further include a tag defining the maximum number of attempts a student can make before the applet automatically provides the correct answer. In general, an exam may include a several questions, and the maximum number of attempts defined by the applet can vary according to the difficulty of each question. For example, an exam may include two questions, the first of which may be deemed by the administrator to be easier than the second. In such a case, the maximum attempts may be set to a smaller number for the first question than the second question. This provides the student more opportunities to obtain the right answer for the second, more difficult question.

One advantage to providing the answers to the exam question in a separate file, instead of the HTML source file that references the JAVA applet, is that a user cannot cheat by looking for the answers to a question in the source file, which is usually freely readable. Second, the JAVA applet requires the correct answer, to check whether or not a student's reply is accurate, but does not require the question. Thus, it is convenient to utilize a separate file as input to the JAVA applet that contains answers but no questions. The definition file can be altered, and subsequently used by the JAVA applet, without having to recompile or rejar the applet. Hence, the use of a definition file facilitates the introduction of new questions and the correction of errors. For example, after the applet executes, it may become evident that there is an error, such as a misspelled word in a message provided to the student. The misspelled word can be modified directly in the definition file, and the JAVA code run again, without having to recompile and/or rejar the applet.

FIG. 8 illustrates the steps involved for an on-line educational course developer to create the fill-in-the-blank applet of the illustrative embodiment of the present invention. At some point in the educational course, the developer may include the fill-in-the-blank applet of the present invention to test the user's knowledge of the presented material. First, in step 80, the developer embeds a snippet in a course page of the on-line educational course for calling the fill-in-the-blank applet. The snippet directs the browser and the user to an HTML document containing the fill-in-the-blank applet. For example, a suitable code fragment in a course page for calling a pop-up HTML page containing the applet according to the teachings of the present inventions is as follows:

<a href=“HOTTEXT?DialogURL=self-check/self-check.html&DialogWidth=640&DialogHeight=480&DialogTitle=Self-Check&pgtype=framehottext”><img alt=self-check border=0 src=“content:/images/self-check.gif”></a>

The above code allows a user to launch a pop-up page containing an examination question. The pop-up page of the illustrative embodiment has a width of 640 pixels and a height of 480 pixels.

Next, in step 81, the developer populates the question text and builds the pop-up page for the applet. The pop-up page coding includes the above-described applet tag or another suitable tag for executing a fill-in-the-blank applet according to the teachings of the present invention. According to a preferred practice of the invention of the invention, the developer sets the width dimension of applet in the applet tag such that the function buttons (i.e. the check button and the reset button) are visible.

The developer creates a fill-in-the-blank definition file in step 82, including the desired parameters and tags, as described above. Finally, in step 83, the developer tests the functionality and desired presentation of the fill-in-the-blank applet within an on-line educational course.

To implement the fill-in-the-blank applet of the present invention, the fill-in-the-blank applet includes computer executable instructions stored on a computer readable medium. The medium can include a hard disk, RAM medium CD-ROM, or diskette, for example. The instructions can be stored on a server that can be remote from the user. To run the application, the user can download the instructions to a computer readable medium of a local computer. The instructions can then be downloaded from the computer readable medium of the local computer to a local processor of the local computer, where the instructions are executed with the help of a virtual machine. A graphical user interface is generated by the instructions for displaying a question and a text field. The interface allows a user to enter an answer to the question in the text field.

Although many of the foregoing examples have highlighted the use of JAVA in the present invention, other computer languages executed by virtual machines may be utilized for this purpose. As known to those of ordinary skill in the art, a virtual machine is an abstract computing machine having an instruction set and being capable of manipulating various memory areas at run time. A well-known virtual machine is the P-Code machine of UCSD Pascal, and the JAVA virtual machine. The JAVA virtual machine does not assume any particular implementation technology, host hardware, or host operating system. It is not necessarily interpreted, and can be implemented by compiling its instruction set to that of a silicon processor. The JAVA virtual machine may also be implemented in microcode or directly in silicon.

These examples are meant to be illustrative and not limiting. The present invention has been described by way of example, and modifications and variations of the exemplary embodiments will suggest themselves to skilled artisans in this field without departing from the spirit of the invention. For example, the present invention is not limited to a JAVA applet executed from a Web browser, and can include any program executed from another application. The described applet is not limited to execution from a pop-up Web page and can be embedded in any suitable document code written in any suitable programming language. Alternately, the question and/or instructions to the user can be part of a definition file for the applet, rather than a part of a static background created by a Web page or other suitable document. Features and characteristics of the above-described embodiments may be used in combination. This description, including the written code, is to be construed as illustrative only and is for the purpose of teaching those skilled in the art the best mode for carrying out the invention. The preferred embodiments are merely illustrative and should not be considered restrictive in any way. Details of the structure may vary substantially without departing from the spirit of the invention, and exclusive use of all modifications that come within the scope of the appended claims is reserved. It is intended that the invention be limited only to the extent required by the appended claims and the applicable rules of law. The scope of the invention is to be measured by the appended claims, rather than the preceding description, and all variations and equivalents that fall within the range of the claims are intended to be embraced therein.

1. In an electronic device that provides an on-line educational course, a method comprising:
providing an interactive fill-in-the-blank applet, wherein said applet generates a graphical user interface displaying a text box, a question and instructions to a user to enter an answer to the question in the text box; and
forwarding the applet from the electronic device to a remote client.

2. The method of claim 1, wherein said applet provides feedback to the user indicating whether an answer entered by the user is correct.

3. The method of claim 1, wherein said applet permits a predetermined number of attempts by the user to enter a correct answer.

4. The method of claim 3, wherein said applet automatically provides a correct answer in the text box after the user surpasses said predetermined number of attempts.

5. The method of claim 4, wherein said applet prevents the user from entering an answer after said predetermined number of attempts.

6. In an electronic device that provides an on-line educational course, a method comprising:
receiving a request for a Web page at the electronic device from a remote client; and
in response to said receiving step, sending a Web page containing a question and a fill-in-the-blank applet embedded therein to the remote client, wherein said applet generates a graphical user interface (GUI) including instructions to a user to enter an answer to the question provided by said Web page.

7. The method of claim 6, wherein said Web page comprises a page of an on-line educational course.

8. The method of claim 6, wherein said Web page includes an applet tag instructing a browser to execute instructions for running the fill-in-the-blank applet.

9. The method of claim 6, wherein the fill-in-the-blank applet includes a definition file defining a correct answer to the question.

10. The method of claim 9, wherein said definition file is separate from a source code for said Web page to prevent a user from obtaining the correct answer by viewing the source code.

11. A computer-readable medium for use in an electronic device that provides an on-line educational course, comprising
instructions for running a fill-in-the-blank applet for displaying a question and a text box to a user, wherein the user can enter an answer to the question in the text box.

12. The computer-readable medium of claim 11, wherein the instructions are executable on a virtual machine.

13. The computer-readable medium of claim 11, wherein the instructions are stored on a server and downloaded to a local processor of the user.

14. The computer-readable medium of claim 11, wherein the medium includes hypertext markup language (HTML) code to reference the applet.

15. The computer-readable medium of claim 14, wherein the HTML code includes the question.

16. The computer-readable medium of claim 15, further comprising a definition file indicating a correct answer for said question, said definition file being separate from the HTML code to prevent the user from obtaining the correct answer by looking at the HTML code.

17. An electronic device for providing an on-line educational course comprising
a processor;
a display screen; and
memory including a Web page having an interactive fill-in-the-blank applet embedded therein,
wherein said processor executes said fill-in-the-blank applet to generate a graphical user interface on said display screen, said graphical user interface displaying a question, a text box and instructions to a user to enter an answer to the question in said text box.

18. The electronic device of claim 17, further comprising a browser for locating and displaying said Web page.

19. The electronic device of claim 18, further comprising a network connection for connecting said electronic device to a computer network.

20. The electronic device of claim 17, further comprising input media to allow the user to enter said answer.
